(19) United States
(12) Patent Application Publication
(10) Pub. No.: US 2022/0327429 A1
(43) Pub. Date: Oct. 13, 2022

(54) Classification of AI Modules

(71) Applicant: Volkswagen Aktiengesellschaft, Wolfsburg (DE)

(72) Inventors: Ruby Moritz, Wolfsburg (DE); Peter Schlicht, Wolfsburg (DE); Fabian Hüger, Wolfenbüttel (DE); Nikhil Kapoor, Wolfsburg (DE)

(73) Assignee: Volkswagen Aktiengesellschaft, Wolfsburg (DE)

(21) Appl. No.: 17/638,829

(22) PCT Filed: Aug. 26, 2020
(86) PCT No.: PCT/EP2020/073851

§ 371 Date: Feb. 27, 2022

(30) Foreign Application Priority Data
Aug. 29, 2019 (DE) 10 2019 213 061.5

(51) Int. Cl. G06N 20/20; G06N 3/04; B60W 60/00

(52) U.S. Cl. CPC G06N 20/20; G06N 3/0454; B60W 60/001

(57) ABSTRACT

The present invention relates to a method for processing input data provided by a sensor system of a motor vehicle, and also relates to a classifier provided using such a method. In a first step, an AI module to be classified is selected. In addition, a suitable test data set is selected. The AI module is then applied to data points of the test data set. Associated ground truths and contextual parameters are known for the data points. On the basis of the outputs of the AI module, a functional quality is then determined for each of the data points. Finally, a classifier for the AI module is created, which outputs a functional quality for given contextual parameters.

### CROSS-REFERENCE TO RELATED APPLICATIONS

This application claims priority to German Patent Application No. DE 10 2019 213 061.5, filed on Aug. 29, 2019 with the German Patent and Trademark Office. The contents of the aforesaid Patent Application are incorporated herein for all purposes.

### TECHNICAL FIELD

The present invention relates to a method, a computer program with instructions, and a device for providing a classifier for an AI module for processing input data provided by a sensor system of a motor vehicle, and also relates to a classifier provided using such a method. The invention also relates to a method, a computer program with instructions, and a device for configuring a control system of a motor vehicle with a library of AI modules for processing input data provided by a sensor system of the motor vehicle, and also relates to a motor vehicle which uses such a method or such a device.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

(Highly) automated driving cannot be realized at this point in time without artificial intelligence (AI)-based methods and, in particular, image data processing based on deep neural networks. However, AI models, even if designed to solve the same task, are very versatile and also differ greatly in their functional quality. In this context, the term functional quality describes the goodness or quality of the AI model with respect to the intended function or task. In current approaches, AI models are mainly differentiated based on their architecture and the data used in training. As a rule, attempts are made to compensate for insufficient functional quality by adding training data or increasing the complexity of the architecture.

Simple approaches to the use of artificial intelligence in motor vehicles are limited to the use of a single AI module or an ensemble of AI modules and its optimization. An AI module is understood here as a software component through which an AI model is implemented.

In another approach, the focus is not on developing a function that works well and safely in all situations. Rather, a set of good functions is combined, i.e., different AI modules are dynamically combined on the vehicle side.

### SUMMARY

A need exists for providing solutions that support a dynamic combination of available AI modules.

The need is addressed by a method, by a computer program with instructions, by a device, and by a classifier according to the independent claims. Embodiments of the invention are described in the dependent claims, the following description, and the drawings.

### BRIEF DESCRIPTION OF THE DRAWINGS

FIG. 1 shows schematically an exemplary method for providing a classifier for an AI module for processing input data provided by a sensor system of a motor vehicle;

FIG. 2 shows a first embodiment of a device for providing a classifier for an AI module for processing input data provided by a sensor system of a motor vehicle;

FIG. 3 shows a second embodiment of a device for providing a classifier for an AI module for processing input data provided by a sensor system of a motor vehicle;

FIG. 4 schematically shows an exemplary method for configuring a control system of a motor vehicle with a library of AI modules for processing input data provided by a sensor system of the motor vehicle;

FIG. 5 shows a first embodiment of a device for configuring a control system of a motor vehicle with a library of AI modules for processing input data provided by a sensor system of the motor vehicle;

FIG. 6 shows a second embodiment of a device for configuring a control system of a motor vehicle with a library of AI modules for processing input data provided by a sensor system of the motor vehicle;

FIG. 7 schematically shows an exemplary motor vehicle in which a solution is realized;

FIG. 8 shows schematically a system diagram of an embodiment for providing a classifier for an AI module for processing input data provided by a sensor system of a motor vehicle; and

FIG. 9 shows schematically a system diagram of an embodiment for configuring a control system with a library of AI modules.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a method for providing a classifier for an AI module for processing input data provided by a sensor system of a motor vehicle comprises the steps of:
Applying the AI module to two or more data points from a test data set, wherein associated ground truths and contextual parameters are known for the two or more data points;
Determining a functional quality for each of the two or more data points; and
Creating a classifier for the AI module that outputs a functional quality for given contextual parameters.

In some embodiments, a computer program includes instructions that, when executed by a computer, cause the computer to perform the following steps for providing a classifier for an AI module for processing input data provided by a sensor system of a motor vehicle:
Applying the AI module to two or more data points from a test data set, wherein associated ground truths and contextual parameters are known for the two or more data points;
Determining a functional quality for each of the two or more data points; and
Creating a classifier for the AI module that outputs a functional quality for given contextual parameters.

The term computer is to be understood broadly. In particular, it also includes workstations, distributed systems and other processor-based data processing devices.

For example, the computer program may be provided for electronic retrieval or stored on a computer-readable storage medium.

In some embodiments, a device for providing a classifier for an AI module for processing input data provided by a sensor system of a motor vehicle comprises:
a test module for causing the AI module to be applied to two or more data points from a test data set, wherein associated ground truth and contextual parameters are known for the two or more data points; and
an evaluation module for determining a functional quality for each of the two or more data points and for creating a classifier for the AI module that outputs a functional quality for given contextual parameters.

When using AI modules or the AI models realized by these AI modules, it should be noted that there is a dependency between the functional quality of an AI model and the data it processes. This dependence ensures that AI models are not good or bad per se, but have an environment-dependent functional quality. By using the solution according to the teachings herein, a meaningful description of AI models and their capabilities can be created in a test phase. In doing so, a list of the most meaningful properties can be determined as a metric for the performance of an AI module. The AI models can thus not only be better understood, but also be used in more diverse ways, for example as ensembles of expert models.

In the testing phase, a classification system based on a set of contextual dimensions, a set of AI modules, and a set of test data evaluates the AI modules with respect to their expected functional quality relative to individual contextual parameters. The contextual parameters may comprise, for example, properties in the context of the data points or properties of an architecture of the AI modules. Here, the term data point refers to the input data for a given situation. For the test data, the ground truth is known, i.e., the correct results are available for the respective input data. In addition, the contextual parameters for the evaluation of the data with regard to the context dimensions are known for the test data. The contextual assignment makes the resulting classification comprehensible, testable and validatable. The resulting classifier is set up to classify the AI modules based on contextual parameters of input data with respect to the expected functional quality.

In some embodiments, the AI module realizes an AI model or a family of AI models in the sense of an ensemble. Usually, a single AI model is realized in an AI module, e.g., a neural network, which is classified in the context of the testing phase. However, the solution according to the teachings herein may also be used to determine an empirically based weighting function for the joint inference of a family of AI models in the sense of an ensemble, i.e., a collective of AI models that process the same input data.

In some embodiments, for determining the functional quality for a data point, an output of the AI module for the data point is compared with the associated ground truth. For this purpose, for example, an IoU metric (IoU: Intersection over Union; ratio between intersection and union, also referred to as Jaccard coefficient) may be used. Through the comparison to the ground truth, the functional quality can be determined in a simple way. In this context, the use of an IoU metric has proven useful, especially for AI modules for object recognition.

In some embodiments, the classifier is formed by a neural network. This has the benefit that the classifier may be trained in the test phase without having to know a relevance of the contextual parameters in advance. However, the classifier may also be realized by other functions.

For example, a classifier for an AI module is provided by means of a method according to the teachings herein. By executing such a classifier on given input data, a situation-dependent evaluation of the AI modules available for processing the input data can be performed.

In some embodiments, a method for configuring a control system of a motor vehicle with a library of AI modules for processing input data provided by a sensor system of the motor vehicle comprises the steps of:
Capturing input data to be processed by the AI modules;
Evaluating the AI modules based on contextual parameters; and
Determining an AI module or a combination of AI modules and associated weights to be used for the input data.

In some embodiments, a computer program comprises instructions that, when executed by a computer, cause the computer to perform the following steps for configuring a control system of a motor vehicle with a library of AI modules for processing input data provided by a sensor system of the motor vehicle:
Capturing input data to be processed by the AI modules;
Evaluating the AI modules based on contextual parameters; and
Determining an AI module or a combination of AI modules and associated weights to be used for the input data.

The term computer is to be understood broadly. In particular, it also comprises control devices and other processor-based data processing devices.

For example, the computer program may be provided for electronic retrieval or stored on a computer-readable storage medium.

In some embodiments, a device for configuring a control system of a motor vehicle with a library of AI modules for processing input data provided by a sensor system of the motor vehicle has:
a data module for capturing input data to be processed by the AI modules;
a classifier for evaluating the AI modules based on contextual parameters; and
an evaluation module for determining an AI module or a combination of AI modules and associated weights to be used for the input data.

The solution according to the teachings herein determines in a test phase those conditions or contextual parameters that have the most relevant influence on the functional properties of the available AI modules, for example deep neural networks for use in automatic driving. The classifier now uses these previously determined conditions to determine a particularly effective combination of several AI modules for the given input data in order to increase the effectiveness of the overall system.

It is beneficial to use a method or device according to the teachings herein in a motor vehicle. Use of the described solution is particularly useful if automatic driving of autonomy levels or level 4 or 5 is to be implemented. In this context, the AI modules may be set up in particular to perform environment recognition for an automatic driving function of a motor vehicle.

For example, the different AI modules may be adapted to different lighting conditions, different speeds, different vehicle environments, different driving situations, different environmental conditions, different driving conditions, or different objectives.

Adaptation to different lighting conditions is particularly beneficial for environment detection for an automatic driving function in changing lighting conditions. For example, the lighting conditions may change due to a change in the weather, driving into a tunnel or driving out of a tunnel, or a very short twilight, such as occurs near the equator, for example. An AI module can be provided as an expert system for each of the different lighting conditions.

Adaptation to different speeds is useful for 3D object recognition, for example. Here, it may be useful to provide AI modules as expert systems for different speeds of the vehicle, e.g., in case the vehicle drives onto a road with a speed limit that differs significantly from the speed limit of the previously traveled road.

When adapting to different vehicle environments, a distinction can be made, for example, between urban and rural environments, but also whether the vehicle is located in the city center or near a school or hospital.

When adapting to different driving situations, AI modules can, for example, be provided for driving on the highway, in parking garages, in traffic jams, or for complex intersections with a specific Car2X infrastructure.

With regard to adaptation to different environmental conditions, AI modules may be provided, for example, for specific weather conditions, lighting conditions, traffic densities, road types, times of day, or geographies. In this context, pedestrian density can also be considered. In particular, expert systems may be provided for roads with a high pedestrian density and expert systems for detecting pedestrians at different distances. When pedestrian density is high, the expert system must be able to detect the intent of pedestrians in close proximity to the vehicle. When pedestrian density is low, it is usually possible to drive faster. Here, again, it is important to detect pedestrians farther away early on. The intention of these pedestrians, on the other hand, is less important.

The driving behavior of the automatic driving function can be adapted for different driving conditions by using customized AI modules, e.g., the speed, the vehicle type, the presence of a trailer, parameters of the trip, or preferences of the vehicle occupants.

Different objectives can result from legal or environmental constraints. For example, AI modules may be provided for noise-reduced or low-emission driving. Other AI modules may be adapted to specific behavioral rules.

In all of these examples, it is useful to determine, based on contextual parameters, the AI modules to be used and the associated weights for processing the input data.

Further features of the present invention will be apparent from the appended claims and the following description in conjunction with the FIGS.

For a better understanding of the principles of the present invention, further embodiments will be discussed in more detail below with reference to the FIGS. It is understood that the invention is not limited to these embodiments and that the features described may also be combined or modified without departing from the scope of the invention as defined in the appended claims. Specific references to components, process steps, and other elements are not intended to be limiting. Further, it is understood that like parts bear the same or similar reference numerals when referring to alternate FIGS.

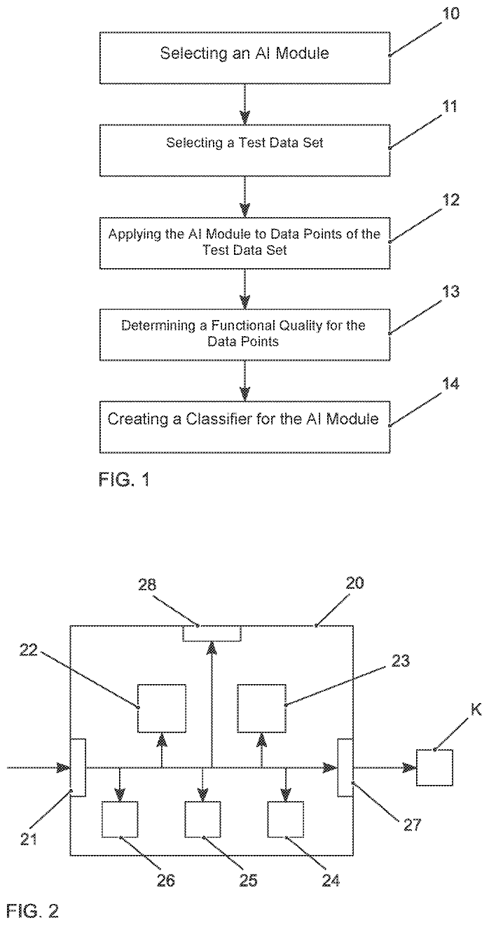

FIG. 1 schematically shows a method for providing a classifier for an AI module for processing input data provided by a sensor system of a motor vehicle. In a first step, an AI module to be classified is selected 10. The AI module realizes, for example, an AI model or a family of AI models in the sense of an ensemble. In addition, a suitable test data set is selected 11. The AI module is then applied to data points of the test data set 12. For the data points, associated ground truths and contextual parameters are known. The contextual parameters may comprise, for example, properties in the context of the data points or properties of an architecture of the AI module. Based on the outputs of the AI module, a functional quality is then determined for each of the data points 13. For this purpose, a comparison with the respective associated ground truth can take place, e.g., using an IoU metric. Finally, a classifier for the AI module is created 14 which classifier outputs a functional quality for given contextual parameters. For example, the classifier can be formed by a neural network.

FIG. 2 shows a simplified schematic representation of a first embodiment of a device 20 for providing a classifier for an AI module for processing input data provided by a sensor system of a motor vehicle. The AI module realizes, for example, an AI model or a family of AI models in the sense of an ensemble. The device 20 has an input 21 via which, for example, data of a test data set may be received. However, such a test data set may also be held in a database 22 of the device 20. A test module 23 causes a selected AI module to be applied to data points of a selected test data set. For the data points, associated ground truths and contextual parameters are known. The contextual parameters may comprise, for example, properties in the context of the data points or properties of an architecture of the AI module. Based on the outputs of the AI module, an evaluation module 24 subsequently determines a functional quality for each of the data points. To do so, the evaluation module 24 may perform a comparison with the respective associated ground truth, for example, by using an IoU metric. In addition, the evaluation module 24 creates a classifier K for the AI module, which classifier K outputs a functional quality for given contextual parameters. To do this, the evaluation module 24 may access the classifier K, for example, via an output 27 of the device 20. The creation of the classifier K may alternatively be performed by another stand-alone module. For example, the classifier K may be formed by a neural network.

The test module 23 and the evaluation module 24 can be controlled by a control unit 25. If necessary, settings of the test module 23, of the evaluation module 24 or of the control unit 25 can be changed via a user interface 28. The data arising in the device 20 can be stored in a memory 26 if required, for example for later evaluation or for use by the components of the device 20. The test module 23, the evaluation module 24 and the control unit 25 can be implemented as dedicated hardware, for example as integrated circuits. Of course, they may also be partially or fully combined or implemented as software running on a suitable processor, for example a GPU or a CPU. The input 21 and the output 27 may be implemented as separate interfaces or as a combined bidirectional interface.

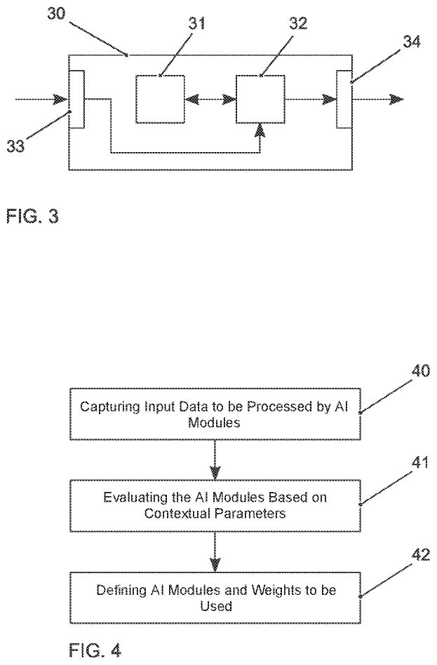

FIG. 3 shows a simplified schematic representation of a second embodiment of a device 30 for providing a classifier for an AI module for processing input data provided by a sensor system of a motor vehicle. The device 30 has a processor 32 and a memory 31. For example, the device 30 is a computer or a control device. Instructions that, when executed by the processor 32, cause the device 30 to perform the steps according to one of the described methods, are stored in the memory 31. The instructions stored in the memory 31 thus embody a program executable by the processor 32 which program realizes the method according to the respective method. The device 30 has an input 33 for receiving information, for example data of a test data set. Data generated by the processor 32 are provided via an output 34. Furthermore, said data can be stored in the memory 31. The input 33 and the output 34 may be combined to form a bidirectional interface.

The processor 32 may comprise one or more processing units, such as microprocessors, digital signal processors, or combinations thereof.

The memories 26, 31 of the described embodiments may have both volatile and non-volatile memory regions and may comprise a wide variety of storage devices and storage media, for example, hard disks, optical storage media, or semiconductor memories.

FIG. 4 schematically shows a method for configuring a control system of a motor vehicle with a library of AI modules for processing input data provided by a sensor system of the motor vehicle. In a first step, input data to be processed by the AI modules is captured 40. The AI modules are then evaluated 41 based on contextual parameters. For this purpose, a classifier previously created as described above can be used, which can be formed by a neural network, for example. The contextual parameters may include, for example, properties in the context of the input data or properties of an architecture of the AI modules. Based on the evaluation, an AI module to be used for the input data or a combination of AI modules to be used and associated weights are finally determined 42.

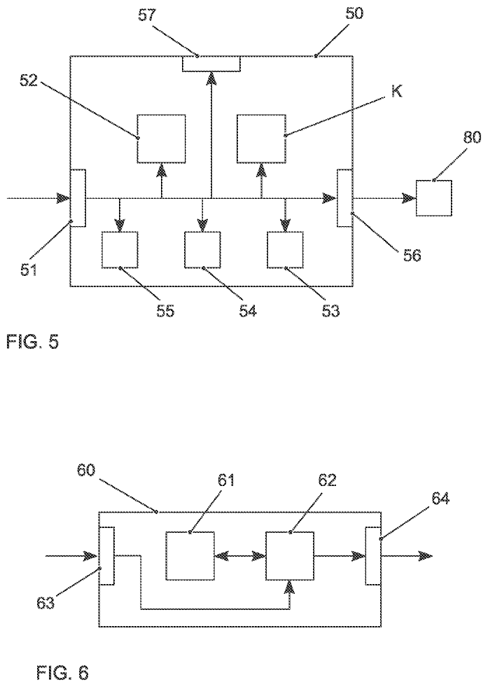

FIG. 5 shows a simplified schematic representation of a first embodiment of a device 50 for configuring a control system of a motor vehicle with a library of AI modules for processing input data provided by a sensor system of the motor vehicle. The device 50 has an input 51 through which input data to be processed by the AI modules is received and can be captured by a data module 52. A classifier K, which may be formed by a neural network, for example, then evaluates the available AI modules based on contextual parameters. The contextual parameters may include, for example, features in the context of the input data or features of an architecture of the AI modules. Finally, an evaluation module 53 determines, based on the evaluation, an AI module to be used for the input data or a combination of AI modules to be used and associated weights. Information regarding the AI modules to be used and a weight to be used may be output to a fusion module 80 via an output 56 of the device 50.

The data module 52 and the evaluation module 53 can be controlled by a control unit 54. If necessary, settings of the data module 52, of the evaluation module 53 or of the control unit 54 can be changed via a user interface 57. The data arising in the device 50 may be stored in a memory 55 if required, for example for later evaluation or for use by the components of the device 50. The data module 52, the evaluation module 53 and the control unit 54 can be realized as dedicated hardware, for example as integrated circuits. Of course, they may also be partially or fully combined or implemented as software that runs on a suitable processor, for example a GPU or a CPU. The input 51 and the output 56 may be implemented as separate interfaces or as a combined bidirectional interface.

FIG. 6 shows a simplified schematic representation of a second embodiment of a device 60 for configuring a control system of a motor vehicle with a library of AI modules for processing input data provided by a sensor system of the motor vehicle. The device 60 has a processor 62 and a memory 61. For example, the device 60 is a computer or a control unit. Instructions are stored in the memory 61 that, when executed by the processor 62, cause the device 60 to perform the steps according to one of the described methods. The instructions stored in the memory 61 thus embody a program executable by the processor 62 which realizes the method according to the respective method. The device 60 has an input 63 for receiving information, for example input data to be processed by the AI modules. Data generated by the processor 62 are provided via an output 64. Furthermore, they may be stored in the memory 61. The input 63 and the output 64 may be combined to form a bidirectional interface.

The processor 62 may comprise one or more processing units, such as microprocessors, digital signal processors, or combinations thereof.

The memories 55, 61 of the described embodiments may have both volatile and non-volatile memory regions and may comprise a wide variety of storage devices and storage media, for example, hard disks, optical storage media, or semiconductor memories.

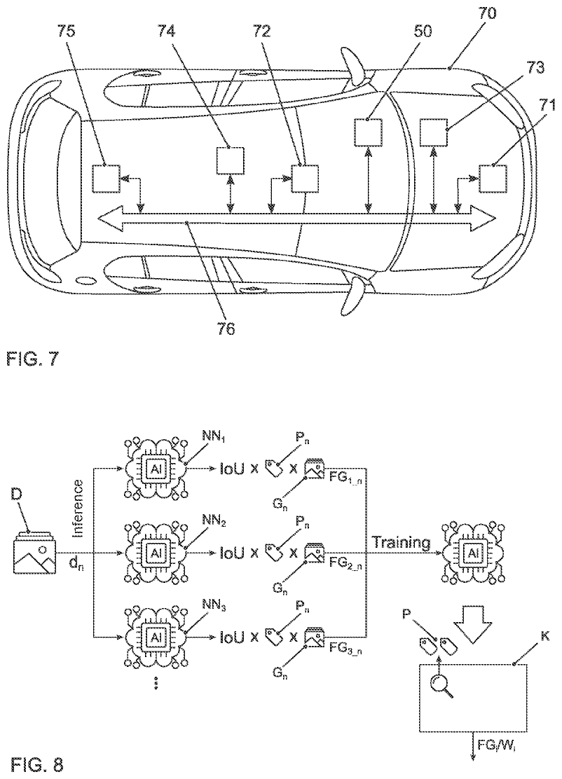

FIG. 7 schematically depicts a motor vehicle 70 in which a solution according to the teachings herein is realized. The motor vehicle has a control system 71 for automated or highly automated driving, which is configured by a device 50. In FIG. 7 the device 50 is an independent component, but it can also be integrated in the control system 71. To select AI modules from a library of AI modules, the device 50 uses a set of input data. This may be, for example, environmental data from an environmental sensor system 72 installed in the motor vehicle 70 or operating parameters of the motor vehicle 70 provided by control devices 73. A further component of the motor vehicle 70 is a data transmission unit 74, via which, among other things, a connection to a backend can be established, for example in order to obtain additional or modified AI modules. A memory 75 is provided for storing the library of AI modules or further data. Data exchange between the various components of the motor vehicle 70 takes place via a network 76.

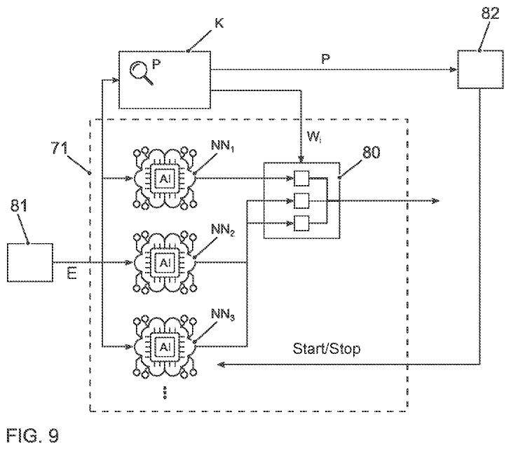

In the following, another embodiment is discussed using FIG. 8 and FIG. 9 as examples.

Distinctive properties in the context of the input data to be processed influence to a certain extent the functional quality of the processing AI modules. Such properties can be very diverse and are not necessarily intuitive for humans, such as the distribution of special color values, contrasts, or specific frequencies. Additionally, architectural properties of the AI modules also play a role. For example, specific features in the composition of a neural network have an impact on its performance. For example, if in addition to a learned neural network, a rule-based knowledge base for allowable road signs is also present, the resulting AI model will have better sign recognition performance than a comparable AI model without this knowledge base. Properties in the context of the input data to be processed include all those influences on the data that affect, or at least can affect, the functional behavior of the AI module. Such can be semantic, such as weather, traffic, environment, etc., as well as non-intuitive as described above.

FIG. 8 schematically shows a system diagram of a solution for providing a classifier K for an AI module NNᵢ for a processing of input data provided by a sensor system of a motor vehicle. The classification system uses a set of AI modules NNᵢ, e.g., trained neural networks, as candidates for later execution in a specific environment. The AI modules NNᵢ are provided for the same task, e.g., an object recognition or a semantic segmentation, but differ in terms of architecture, training data, and training parameters.

During a test phase, all given AI modules NNᵢ are now used for inferences for all data points dₙ from a test data set D. Here, the term inference refers to the process of using the trained model for conclusions. By comparing the outputs of the AI modules NNᵢ with the respective ground truth Gₙ, in this example using an IoU metric, the functional quality FG_{i_n} for each data point dₙ with the given contextual parameters Pₙ is determined. This information can now be used to train, for example, a neural network that learns during training the relevance of the different contextual parameters Pₙ as well as the dependence of the functional quality FGᵢ of the different AI modules NNᵢ on the contextual parameters Pₙ. In this way, a classifier K is created that outputs a functional quality FGᵢ or weights Wᵢ corresponding to the functional quality FGᵢ for given contextual parameters P for all AI modules NNᵢ independent of data points. Alternatively, the classifier K can output an empirically based weighting function for the joint inference of a family of AI modules NNᵢ in the sense of an ensemble.

FIG. 9 schematically shows a system diagram of a solution for configuring a control system 71 with a library of AI modules NNᵢ. With the aid of a classifier K, during operation of the control system 71, for example in a vehicle, the contextual parameters P are extracted from the input data E obtained by means of a sensor system 81. Based on these contextual parameters P, an optimal combination of AI modules NNᵢ and associated weights Wᵢ are determined. This is for example done synchronously with the data processing in the AI modules NNᵢ, since in order for the fusion of the outputs of the AI modules NNᵢ to take place, it must be known how to evaluate the respective output. A fusion module 80 combines the outputs of the selected AI modules NNᵢ according to the weights Wᵢ provided by the classifier K. Furthermore, the contextual parameters P determined by the classifier K can be passed to a selection unit 82, which can selectively start or stop individual AI modules NNᵢ on the basis of the parameters P.

### LIST OF REFERENCE NUMERALS

10 Selecting an AI module

11 Selecting a test data set

12 Applying the AI module to data points of the test data set

13 Determining a functional quality for the data points

14 Creating a classifier for the AI module

20 Device

21 Input

22 Database

23 Test module

24 Evaluation module

25 Control unit

26 Memory

27 Output

28 User interface

30 Device

31 Memory

32 Processor

33 Input

34 Output

40 Capturing of input data to be processed by AI modules

41 Evaluating the AI modules based on contextual parameters

42 Determining AI modules and weights to be used

50 Device

51 Input

52 Data module

53 Evaluation module

54 Control unit

55 Memory

56 Output

57 User interface

60 Device

61 Memory

62 Processor

63 Input

64 Output

70 Motor vehicle

71 Control system

72 Environmental sensor system

73 Control device

74 Data transmission unit

75 Memory

76 Network

80 Fusion module

81 Sensor system

dₙ Data point

D Test data set

E Entry date

FGᵢ, FG_{i_n} Functional quality

Gₙ Ground truth

K Classifier

NNᵢ AI module

P, Pₙ Contextual parameter

Wᵢ Weight

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for providing a classifier for an AI module for processing input data provided by a sensor system of a motor vehicle, comprising the steps of:
determining one or more outputs of the AI module by applying the AI module to two or more data points from a test data set, wherein associated ground truths and contextual parameters are known for the two or more data points;
determining a functional quality for each of the two or more data points by comparing the one or more outputs of the AI module for the data point with the associated ground truth; and
training a classifier for the AI module that outputs a functional quality for given contextual parameters.

2. The method of claim 1, wherein the AI module realizes an AI model or a family of AI models in the sense of an ensemble.

3. The method of claim 1, wherein for determining the functional quality for a data point a comparison of an output of the AI module for the data point with the associated ground truth takes place.

4. The method of claim 3, wherein an IoU metric is used for comparing the output of the AI module for the data point with the associated ground truth.

5. The method of claim 1, wherein the contextual parameters comprise properties in the context of the data points or properties of an architecture of the AI module.

6. The method of claim 1, wherein the classifier is formed by a neural network.

7. The method of claim 1, wherein the AI module is set up to perform an environment detection for an automatic driving function of a motor vehicle.

8. The method of claim 1, wherein different AI modules are adapted to different lighting conditions, different speeds, different vehicle environments, different driving situations, different environmental conditions, different driving conditions, or different objectives.

9. A storage medium comprising instructions which, when executed by a computer, cause the computer to:
determine one or more outputs of the AI module by applying the AI module to two or more data points from a text data set, wherein associated ground truths and contextual parameters are known for the two or more data points;
determine a functional quality for each of the two or more data points by comparing the one or more outputs of the AI module for the data point with the associated ground truth; and
train a classifier for the AI module that outputs a functional quality for given contextual parameters.

10. A device for providing a classifier for an AI module for processing input data provided by a sensor system of a motor vehicle, comprising:
a test circuit for determining one or more outputs of the AI module by causing the AI module to be applied to two or more data points from a test data set, wherein associated ground truths and contextual parameters are known for the two or more data points; and
an evaluation circuit for determining a functional quality for each of the two or more data points by comparing the one or more outputs of the AI module for the data point with the associated ground truth and for training a classifier for the AI module, which classifier outputs a functional quality for given contextual parameter.

11. A classifier for an AI module, wherein the classifier is provided by:
determining one or more outputs of the AI module by applying the AI module to two or more data points from a test data set, wherein associated ground truths and contextual parameters are known for the two or more data points;
determining a functional quality for each of the two or more data points by comparing the one or more outputs of the AI module for the data point with the associated ground truth; and
training the classifier for the AI module.

12. A method for configuring a control system of a motor vehicle with a library of AI modules for processing input data provided by a sensor system of the motor vehicle, comprising:
acquiring input data to be processed by the AI modules;
evaluating the AI modules based on contextual parameters; and
determining an AI module to be used for the input data or a combination of AI modules and associated weights to be used.

13. The method claim 12, wherein the AI modules are set up to perform an environment detection for an automatic driving function of a motor vehicle.

14. The method of claim 12, wherein different AI modules are adapted to different lighting conditions, different speeds, different vehicle environments, different driving situations, different environmental conditions, different driving conditions, or different objectives.

15. A storage medium comprising instructions that, when executed by a computer, cause the computer to:
acquire input data to be processed by AI modules;
evaluate the AI modules based on contextual parameters; and
determine an AI module to be used for the input data or a combination of AI modules and associated weights to be used.

16. A device for configuring a control system of a motor vehicle with a library of AI modules for processing input data provided by a sensor system of the motor vehicle, comprising:
a data circuit for capturing input data to be processed by the AI modules;
a classifier for evaluating the AI modules based on contextual parameters; and
an evaluation circuit for determining an AI module to be used for the input data or a combination of AI modules and associated weights to be used.

17. A motor vehicle, wherein the motor vehicle comprises a device according to claim 16.

18. The method of claim 2, wherein for determining the functional quality for a data point a comparison of an output of the AI module for the data point with the associated ground truth takes place.

19. The method of claim 18, wherein an IoU metric is used for comparing the output of the AI module for the data point with the associated ground truth.

20. A motor vehicle, wherein the motor is set up to:
acquire input data to be processed by the AI modules;
evaluate the AI modules based on contextual parameters; and
determine an AI module to be used for the input data or a combination of AI modules and associated weights to be used.
